(19) United States
(12) Patent Application Publication
(10) Pub. No.: US 2010/0119859 A1
(43) Pub. Date: May 13, 2010

(54) COMPONENT AND A SOLDER

(76) Inventors: Karl-Heinz Manier, Scheyern (DE); Michael Ott, Mulheim an der Ruhr (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/528,715

(22) PCT Filed: Feb. 15, 2008
(86) PCT No.: PCT/EP2008/051867

§ 371 Date: Aug. 26, 2009

(30) Foreign Application Priority Data
Mar. 9, 2007 (EP) 07004959.8

(51) Int. Cl. B23K 35/02; B23K 35/34; B22F 1/00

(52) U.S. Cl. 428/576; 148/24

(57) ABSTRACT

A component and a solder are provided. The solder is used to repair the component including a base material with a directional microstructure. The solder used includes two constituents, a first constituent and a second constituent, including different grain size distributions. The first constituent of the solder includes a composition that corresponds to or is similar to the base material.

### CROSS REFERENCE TO RELATED APPLICATIONS

This application is the US National Stage of International Application No. PCT/EP2008/051867, filed Feb. 15, 2008 and claims the benefit thereof. The International Application claims the benefits of European Patent Office application No. 07004959.8 EP filed Mar. 9, 2007, both of the applications are incorporated by reference herein in their entirety.

### FIELD OF INVENTION

The present invention relates to a component and a solder.

### BACKGROUND OF INVENTION

Nowadays, components of turbines are often made from materials with a directional microstructure. In this context, the term materials with a directional microstructure is to be understood in particular as meaning single-crystal materials and materials which have a grain structure in which the extent of the grains has a common preferential direction. For example, the grains may have a larger dimension in one specific preferential direction than in the other directions. Components with a grain structure of this type are also known as directionally solidified components.

Highly stressed components, such as for example turbine blades or vanes, are subject to high thermal and mechanical stresses in operation, which can lead to material fatigue and, as a result, to cracks. Since it is relatively expensive to produce components from base materials which have a directional microstructure, the general aim is for components of this type to be repaired after damage has occurred. This restores the functionality and allows the component to be used for a further maintenance period.

One way of repairing damaged components is soldering. During this soldering, a solder is applied to the material of the component, i.e. to the base material, in the region of the damage and is joined to the base material by means of the action of heat. However, after the soldering, in the procedure which has been customary hitherto, the solder material does not have a single-crystal or directionally solidified structure. However, an unordered structure brings with it materials properties that are worse than those of a directional microstructure, in particular in the high-temperature range, with the result that the soldered location then has materials properties that are worse than those of the surrounding base material.

Welding processes which can also be used to produce directional microstructures in the welded structures are also available for repairing damaged components with a directional microstructure. A process of this type is disclosed for example in EP 089 090 A1.

Further processes and solder powders used are known from publications U.S. Pat. No. 6,283,356, U.S. Pat. No. 4,705,203, U.S. Pat. No. 4,900,394, U.S. Pat. No. 6,565,678, U.S. Pat. No. 4,830,934, U.S. Pat. No. 4,878,953, U.S. Pat. No. 5,666,643, U.S. Pat. No. 6,454,885, U.S. Pat. No. 6,503,349, U.S. Pat. No. 5,523,170, U.S. Pat. No. 4,878,953, U.S. Pat. No. 4,987,736, U.S. Pat. No. 5,806,751, U.S. Pat. No. 5,783,318, U.S. Pat. No. 5,873,703.

U.S. Pat. No. 6,050,477 discloses a process for joining two component elements, wherein the solder is applied over a large area between the two component parts and a temperature gradient is used in order to generate the same directional microstructure. The entire component is heated.

US 2003/0075587 A1 discloses a repair process of a component with a directionally solidified microstructure, wherein, however, the repaired location does not have the same microstructure as the component that is to be repaired.

U.S. Pat. No. 6,495,793 discloses a welding repair process for nickel-base superalloys, which uses a laser that melts the material supplied via a material conveyor. Moreover, the base material is melted during the welding process. No mention is made of the microstructure of the component or the repair location.

EP 1 258 545 A1 discloses a soldering process without temperature gradients.

EP 1 340 567 A1 discloses a welding process in which additional material is added to the location that is to be repaired and has already been melted. In this case too, the base material is melted. A temperature gradient is likewise used in order to treat the components with a directional microstructure.

U.S. Pat. No. 4,878,953 discloses a welding process for repairing a component with a directional microstructure, wherein material is applied to the location that is to be repaired by means of powder and this location has a fine-grained microstructure. Here too, the base material is melted.

However, welding processes always melt the base material of the component that is to be repaired. Consequently, structurally bearing regions of a component must not be welded, since melting of the base material would destroy the integrity of the directional structure. Consequently, components with a directional microstructure are only repaired by means of the welding processes if the damage is not located in structurally bearing regions of the component. By contrast, if damage occurs in a structurally bearing region of the component, should a directional welded structure be required, this component is declared unrepairable and is replaced with an intact component.

### SUMMARY OF INVENTION

It is an object of the invention to provide a solder and a component which have improved properties.

The object is achieved by the component as claimed in the claims and the solder as claimed in the claims.

The dependent claims give advantageous configurations of the present invention which can be combined with one another in advantageous ways.

### BRIEF DESCRIPTION OF THE DRAWINGS

Exemplary embodiments are explained in more detail in the figures, in which:

FIG. 1 shows a solder according to the invention,

FIG. 2 shows a grain size distribution of a solder according to the invention,

FIGS. 3, 4, 5 show an exemplary embodiment of a process for applying the solder,

FIG. 6 shows a gas turbine,

FIG. 7 shows a perspective view of a combustion chamber,

FIG. 8 shows a perspective view of a turbine blade or vane.

### DETAILED DESCRIPTION OF INVENTION

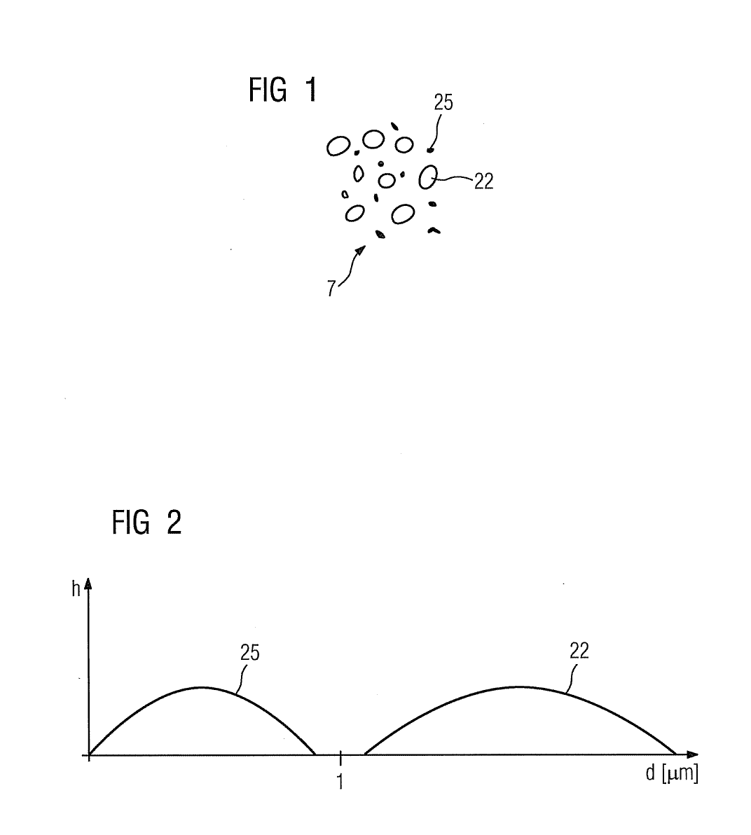

FIG. 1 shows powder particles of a solder 7 according to the invention.

The solder 7 constitutes a mixture of two metallic powder constituents 22, 25, i.e. it includes a first powder constituent 22 made up of coarser particles 22 with grain sizes in the sub-micrometer or micrometer range (0.7 μm-100 μm, in particular ≧0.7 μm to 75 μm or particularly preferably ≧25 μm and 75 μm) and a powder constituent 25 with grain sizes in the nanometer range (FIG. 2), which has grain sizes of less than 500 nanometers. The grain size distribution curves for the powder constituents 22, 25 (FIG. 2) may also partially overlap. However, there are always two distinct and separate maxima in the two grain size distributions of the powder constituents of the solder 7 (FIG. 2).

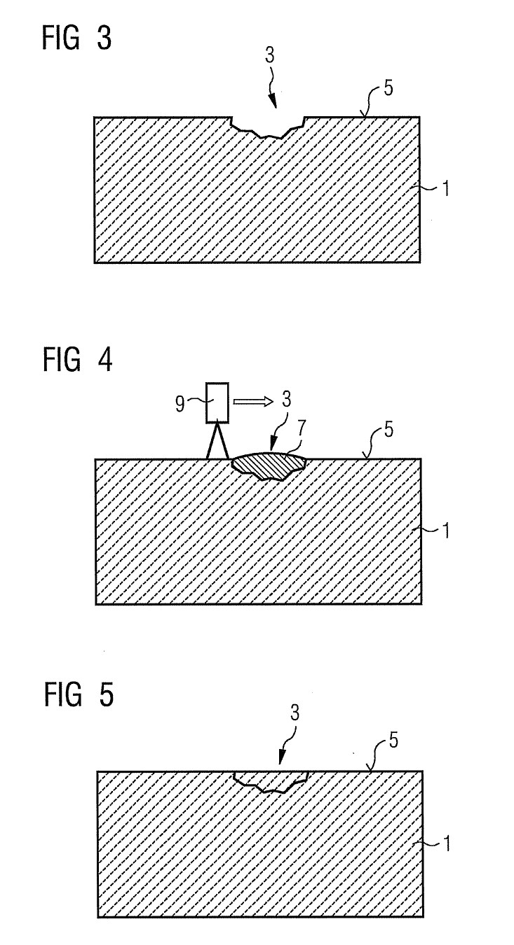

The first constituent 22 and the second constituent 25 preferably consist of different materials. The second constituent 25 preferably corresponds to the material of the base material of a component 1, 120, 130, 155 (FIG. 3, 6, 7, 8) that is to be repaired and is preferably nickel-based. The first constituent 22 preferably has a melting temperature below that of the second constituent 25, since the second constituent 25 is similar or corresponds to the base material of the component 1.

Since the second constituent 25 is similar or corresponds to the base material of the component 1, the melting temperature of the second constituent 25 is lower than that of the base material on account of the grain size effect, since the second constituent 25 has the smaller particles 25 in the nanometer range. The melting temperature of the base material of the component 1, 120, 130, 155 is that of a solid material, i.e. is not influenced by the grain size effect. The melting temperatures of the two constituents 22, 25 of the solder 7 are adapted by the grain size effect of the melting temperature, i.e. the melting temperature of the higher-melting constituent is adapted by the grain size effect to the lower melting temperature of the first constituent 22, i.e. is lowered. Likewise preferably, the melting point of the first constituent 22 may have a higher melting temperature than the second constituent 25. The melting temperatures of the constituents 22, 25 of the solder 7 are, however, always below the melting point of the base material of a component 1 that is to be repaired.

The first constituent 22 preferably constitutes an alloy, which is preferably nickel-based.

Likewise preferably, the second constituent 25 constitutes an alloy, which is preferably nickel-based.

The second constituent 25 may correspond or be similar to the material of the substrate.

A similar composition means that the constituents 22, 25 include at least the main alloying elements (elements forming ≧1% by weight of the alloy) of any alloy composition (base material), and preferably at least all the alloying elements of the alloy of the base material, although their proportions are changed for this constituent of the solder, plus additives (agent that lowers the melting point). The term “ . . . corresponds to the base material” means an identical composition to the base material.

The first constituent 22 may preferably without an agent that lowers the melting point have a lower melting point, since its (22) composition differs from the base material of the component 1, 120, 130, 155. Preferably, the first constituent 22 includes at least one agent that lowers the melting point, and in particular one such agent, in particular boron (B), silicon (Si), carbon (C), hafnium (Hf), titanium (Ti), tantalum (Ta) or zirconium (Zr).

It is possible here to use the same alloy as for the base material of the component: first constituent 22=base material of the component 1+agent that lowers the melting point.

If a substrate of a component 1, 120, 130, 155 is being repaired, there are the following options for the solder 7 whose composition is different than the base material ( [symbol] substrate).

| Constituent | 22 [μm] | 25 [nm] |
|---|---|---|
| Composition | [symbol] substrate | [symbol] substrate |
| of constituent | [symbol] substrate | =substrate |

FIG. 3 illustrates a schematic view of a damaged component 1 that is repaired using the solder 7 according to the invention.

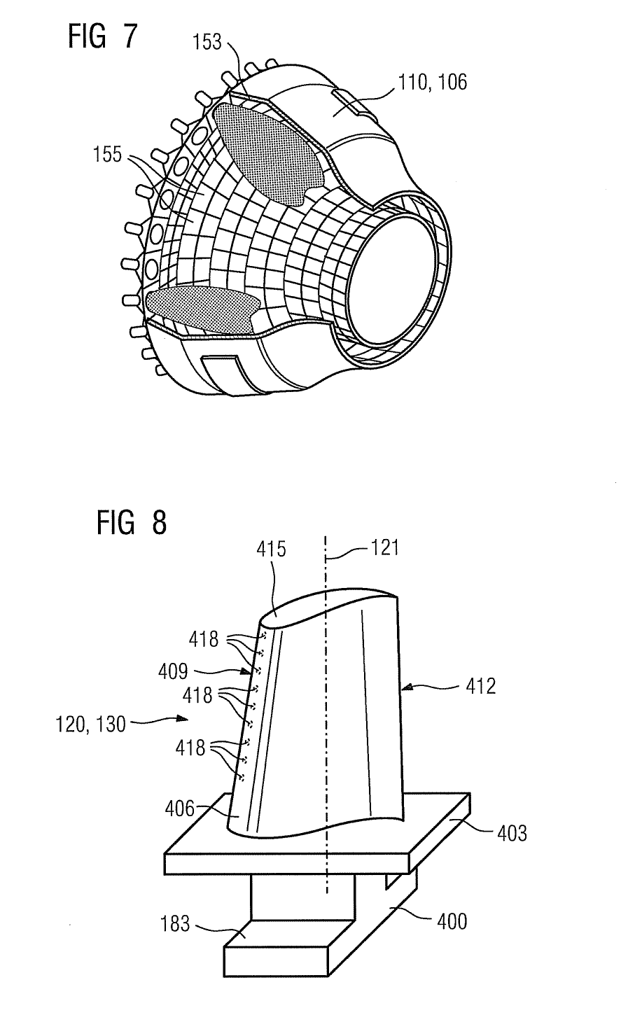

The base material of the component 1, for example a turbine blade or vane 120, 130, (FIG. 7), comprises an alloy, preferably based on nickel, and preferably has a directional microstructure, which is indicated by short diagonal lines in the figures.

The damage 3 to the component 1 is located in the region of the surface 5 and is illustrated as a depression in FIG. 3.

To repair the damaged component 1, a solder 7, which in the present exemplary embodiment is in powder form, is applied to the precleaned damaged location 3 and is then soldered to the base material of the component 1 by means of the action of heat (FIG. 4). It is preferable for all the solder 7 that is needed to be introduced into the preferably precleaned, damage location 3, optionally in a small excess, and in particular for it not to be added in steps during the melting. It is preferable for the solder 7 to be pressed into the damage location 3. This has the advantage that all of the damage location 3 is filled with the solder 7. Particularly in the case of deep cracks 3 (high aspect ratio) with a nonuniform cross-sectional area, according to the prior art an external supply of powder using a powder feeder would not ensure that the solder 7 can reach the tip of the crack.

The solder 7 can be applied and introduced into the damage location 3 in the form of a paste, a slurry, in pure powder form or by means of a foil. It is in this context advantageous for the material composition of the solder 7 to be similar to that of the component 1. However, the solder 7 must comprise at least one constituent with a melting temperature lower than the melting temperature of the base material of the component 1, so that the action of heat melts the solder 7 but not the base material of the component 1. The melting temperature of the solder 7 is preferably at least 30° C. or at least 50° C. lower than the melting temperature of the base material of the component 1, so that there is no risk to the base material. In particular, the difference in melting temperatures is between 50° C. and 70° C. This is particularly important if the base material is superalloy. With superalloys, chromium is vaporized at high temperatures close to its melting temperatures, and consequently the melting temperature of the solder 7 should be as low as possible, thereby maximizing the difference.

The difference in the melting temperature of solder 7 and base material is in particular at least 70° C., preferably 70° C.±4° C. The solder 7 is preferably first of all melted in such a way that it flows into the location 3 that is to be repaired. The temperature required to do this may be higher or lower than the temperatures used to set the directional microstructure.

There is no restriction with regard to the superalloy that is to be soldered. However, the materials PWA 1483, PWA 1484 and RENE N5 have proven particularly advantageous for use of the solder 7 according to the invention. PWA 1483 has a melting point around 1341° C., whereas RENE N5 has a melting point in the region around 1360-1370° C. Therefore, the solder 7 to be used preferably has a melting temperature of 1271° C.

When using high temperatures, a further problem is recrystallization in DS or SX materials, and consequently in this case too it is necessary for there to be a considerable difference between the melting temperature of the solder 7 and the melting temperature of the base material of the component 1.

To realize the action of heat on the solder 7, in the present exemplary embodiment it is preferable for there to be an electron beam gun 9 which irradiates the solder 7 that is to be melted and thereby imparts to it the heat required for melting.

The action of heat on the solder 7 can also be realized by means of a laser beam. The electron beam treatment is preferably carried out in vacuo. In particular in the case of oxidation-sensitive materials, such as, for example in the case of superalloys, oxidation plays an important role, and consequently a heat treatment should be carried out by means of a laser or an electron beam and in vacuo. The electron beam treatment has the advantage of leading to better introduction of energy into the material and the further advantage that the electron beams can be moved contactlessly over the location 3 that is to be repaired by means of coils, which in this case constitute the optics.

During the soldering operation, a temperature gradient is produced in the region of the damage 3 deliberately in a preferential direction of the microstructure of the base material. The temperature gradient can be produced by moving the component 1 and the electron beam gun 9 relative to one another. In the exemplary embodiment, therefore, the electron beam gun 9 is guided over the solder 7 parallel to the surface 5. The rate at which the electron beam gun 9 is guided over the solder 7 is selected in such a manner that the desired temperature gradient is established in the region of the damage 3, i.e. in the solder 7. The temperature gradient induces the formation of an epitaxially directional microstructure when the solder 7 that has been melted by the electron beam gun 9 solidifies again. The steepness of the temperature gradient can be set, for example, by the rate at which the electron beam gun 9 and component 1 are moved relative to one another or by means of the laser power. In this context, the steepness of the gradient is to be understood as meaning the increase or decrease in the temperature per unit length. The steepness of the temperature gradient, which leads to the formation of a directional microstructure in the solidifying solder, is dependent on the composition of the solder 7.

In the present exemplary embodiment, the preferential direction of the directional microstructure in the base material of the component 1 extends from left to right in the plane of the drawing. To induce the formation of a directional microstructure with a preferential direction corresponding to that of the base material in the solidifying solder 7, the electron beam gun 9 is moved relative to the component 1 parallel to the preferential direction of the directional microstructure of the base material.

FIG. 5 shows the component 1 after the damage 3 has been repaired. As indicated by the diagonally running lines in the region of the now solidified solder 7, the solidified solder 7, i.e. the repair material, has a directional microstructure which has the same preferential direction as the directional microstructure of the base material of the component 1.

However, it is also possible to allow the solder 7 to solidify in unidirectional form. This can be for an SX, DS or CC component 1.

The electron beam can also be widened in such a way that, for example, it irradiates all of the solder 7 and at least thereby completely heats said solder.

It is not therefore absolutely imperative that the electron beam gun be moved.

The dissipation of heat from the solder 7 into the substrate of the component 1 produces a temperature gradient within the solder 7. The temperature is highest at the outer surface of the solder 7 and cooler at the interface between the solder 7 and the substrate of the component 1. If appropriate, the component 1 can be cooled or heated on the rear side, opposite the damage 3 or elsewhere, in order to set a desired, specific temperature gradient as a function of the geometry of the component 1 and of the damage 3.

In the present exemplary embodiment, an electron beam gun 9 was used to supply the heat. Alternatively, however, it is also possible to use other optical heating methods, for example illumination with a conventional illumination apparatus. Moreover, it is also possible to use inductive heating methods instead of optical heating methods, in which case the solder is heated by means of heating coils. Finally, it is also possible to use special heating furnaces such as for example a “hot box” or a casting furnace for producing a casting with a directionally directed microstructure. In any case, the process used must be suitable for producing a temperature gradient in the direction desired for solidification in the region of the damage or of the solder-filled damage. If a furnace is used, this can be effected, for example, by means of a stationary furnace which makes it possible to set the action of heat separately in different regions of the furnace.

It is also possible for a foil or a paste that is used to apply the solder 7 to partially include a powder made up of nanopowder. The advantage over the prior art is that is this case the powder is not supplied via a powder feeder, but rather is fed to the location 3 that is to be repaired in ready-compacted form. Supplying a nanopowder via a nozzle to a location 3 that is to be repaired, as is known from the prior art, is almost impossible, since the grains of the nanopowder are much too small and would be very widely scattered during spraying.

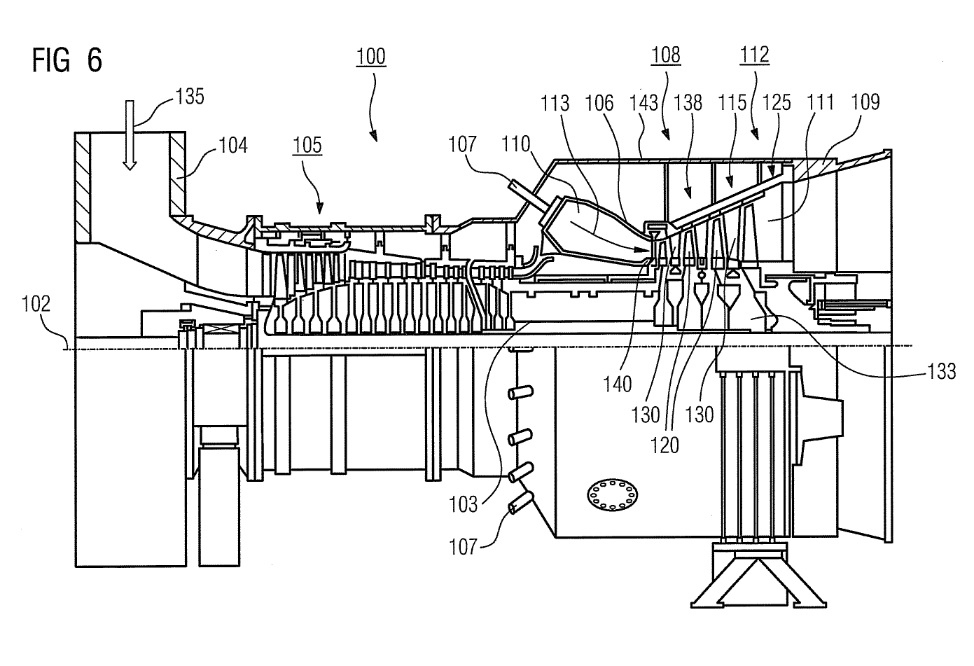

FIG. 6 shows, by way of example, a partial longitudinal section through a gas turbine 100. In the interior, the gas turbine 100 has a rotor 103 with a shaft 101 which is mounted such that it can rotate about an axis of rotation 102 and is also referred to as the turbine rotor. An intake housing 104, a compressor 105, a, for example, toroidal combustion chamber 110, in particular an annular combustion chamber, with a plurality of coaxially arranged burners 107, a turbine 108 and the exhaust-gas housing 109 follow one another along the rotor 103. The annular combustion chamber 110 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium

113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133. A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To be able to withstand the temperatures which prevail there, they can be cooled by means of a coolant. Substrates of the components may likewise have a directional structure, i.e. they are in single-crystal form (SX structure) or have only longitudinally oriented grains (DS structure). By way of example, iron-base, nickel-base or cobalt-base superalloys are used as material for the components, in particular for the turbine blade or vane 120, 130 and components of the combustion chamber 110.

Superalloys of this type are known, for example, from EP 1 204 776 B1, EP 1 306 454, EP 1 319 729 A1, WO 99/67435 or WO 00/44949; these documents form part of the disclosure with regard to the chemical composition of the alloys.

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

FIG. 7 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415. As a guide vane 130, the vane 130 may have a further platform (not shown) at its vane tip 415.

A blade or vane root 183, which is used to secure the rotor blades 120, 130 to a shaft or a disk (not shown), is formed in the securing region 400. The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 can in this case be produced by a casting process by means of directional solidification, by a forging method, by a milling method or combinations thereof.

Workpieces with a single-crystal structure or structures are used as components for machines which, in operation, are exposed to high mechanical, thermal and/or chemical stresses. Single-crystal workpieces of this type are produced, for example, by directional solidification from the melt. This involves casting processes in which the liquid metallic alloy solidifies to form the single-crystal structure, i.e. the single-crystal workpiece, or solidifies directionally. In this case, dendritic crystals are oriented along the direction of heat flow and faun either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have protective layers protecting against corrosion or oxidation e.g. (MCrAlX; M is at least one element selected from the group consisting of iron (Fe), cobalt (Co), nickel (Ni), X is an active element and represents yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1, which are intended to form part of the present disclosure with regard to the chemical composition of the alloy. The density is preferably 95% of the theoretical density. A protective aluminum oxide layer (TGO=thermally grown oxide layer) is formed on the MCrAlX layer (as an intermediate layer or as the outermost layer).

It is also possible for a thermal barrier coating, which is preferably the outermost layer and consists, for example, of ZrO₂, Y₂O₃—ZrO₂, i.e. unstabilized, partially stabilized or completely stabilized by yttrium oxide and/or calcium oxide and/or magnesium oxide, to be present on the MCrAlX.

The thermal barrier coating covers the entire MCrAlX layer. Columnar grains are produced in the thermal barrier coating by means of suitable coating processes, such as for example electron beam physical vapor deposition (EB-PVD). Other coating processes are conceivable, e.g. atmospheric plasma spraying (APS), LPPS, VPS or CVD. The thermal barrier coating may include grains that are porous or contain micro-cracks or macrocracks, in order to improve the resistance to thermal shocks. The thermal barrier coating is therefore preferably more porous than the MCrAlX layer.

The blade or vane 120, 130 may be hollow or solid. If the blade or vane 120, 130 is to be cooled, it is hollow and may also have film-cooling holes 418 (indicated by dashed lines).

FIG. 8 shows a combustion chamber 110 of the gas turbine 100. The combustion chamber 110 is configured, for example, as what is known as an annular combustion chamber, in which a multiplicity of burners 107, which generate flames 156, arranged circumferentially around an axis of rotation 102 open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

Moreover, a cooling system may be provided for the heat shield elements 155 and/or their holding elements, on account of the high temperatures in the interior of the combustion chamber 110. The heat shield elements 155 are then, for example, hollow and may also have cooling holes (not shown) opening out into the combustion chamber space 154.

On the working medium side, each heat shield element 155 made from an alloy is equipped with a particularly heat-resistantprotective layer (MCrAlX layer and/or ceramic coating) or is made from material that is able to withstand high temperatures (solid ceramic bricks). These protective layers may be similar to the turbine blades or vanes, i.e. for example MCrAlX: M is at least one element selected from the group consisting of iron (Fe), cobalt (Co), nickel (Ni), X is an active element and stands for yttrium (Y) and/or silicon and/or at least one rare earth or hafnium (Hf). Alloys of this type are known for example from EP 0 486 489 B1, EP 0 786 017 B1, EP 0 412 397 B1 or EP 1 306 454 A1.

It is also possible for a, for example, ceramic thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide. Columnar grains are produced in the thermal barrier coating by means of suitable coating processes, such as for example electron beam physical vapor deposition (EB-PVD).Other coating processes are conceivable, e.g. atmospheric plasma spraying (APS), LPPS, VPS, or CVD. The thermal barrier coating may include grains that are porous or include microcracks or macrocracks, in order to improve the resistance to thermal shocks.

Refurbishment means that, after they have been used, protective layers may have to be removed from turbine blades 120, 130, heat shield elements 155 (e.g. by sand-blasting). Then, the corrosion and/or oxidation layers and products are removed. If appropriate, cracks in the turbine blade or vane 120, 130 or the heat shield element 155 are also repaired. This is followed by recoating of the turbine blades or vanes 120, 130, heat shield elements 155, after which the turbine blades or vanes 120, 130 or the heat shield elements 155 can be reused.

1.-18. (canceled)

19. A component, comprising:
a solder, the solder, comprising:
a first constituent, and
a second constituent,
wherein only the second constituent includes a composition that corresponds to or is similar to a base material of the component.

20. The component as claimed in claim 19, wherein the component is nickel-based.

21. The component as claimed in claim 19,
wherein only the second constituent of the solder includes the composition that corresponds to the base material.

22. The component as claimed in claim 19,
wherein a first melting temperature of the first constituent is lower than a second melting temperature of the base material.

23. The component as claimed in claim 19,
wherein a third melting temperature of the second constituent is below the second melting point of the base material.

24. The component as claimed in claim 19,
wherein the third melting temperature of the second constituent is between the second melting temperature of the base material and the first melting temperature of the first constituent.

25. The component as claimed in claim 19,
wherein the first melting temperature of the first constituent is between the second melting temperature of the base material and the third melting temperature of the second constituent.

26. A solder, comprising:
a metallic first powder constituent; and
a metallic second powder constituent,
wherein the metallic first powder constituent constitutes a powder with a plurality of grain sizes in a micrometer range of 0.7 μm-100 μm,
wherein the metallic second powder constituent constitutes a powder with the plurality of grain sizes in a nanometer range of ≧500 nm, and
wherein a first material of the first constituent is different than a second material of the second constituent.

27. The solder as claimed in claim 26, wherein a first melting temperature of the first constituent is lower than a second melting temperature of the second constituent.

28. The solder as claimed in claim 26, wherein the first melting temperature is higher than the second melting temperature.

29. The solder as claimed in claim 26, wherein the first constituent is an alloy.

30. The solder as claimed in claim 26, the second constituent is an alloy.

31. The solder as claimed in claim 26, wherein the first constituent does not include an agent that lowers the melting point.

32. The solder as claimed in claim 26, wherein the second constituent does not include an agent that lowers the melting point.

33. The solder as claimed in claim 26, wherein the first constituent includes an agent that lowers the melting point.

34. The solder as claimed in claim 33, wherein the agent is selected from the group consisting of carbon, boron, hafnium, silicon and zirconium.

35. The solder as claimed in claim 33, wherein the agent is tantalum or titanium.

36. The solder as claimed in claim 26, wherein the first constituent forms a largest proportion by volume of the solder.

37. The solder as claimed in claim 29, wherein the first constituent is nickel-based.

38. The solder as claimed in claim 30, wherein the second constituent is nickel-based.
